(19) United States
(12) Patent Application Publication
(10) Pub. No.: US 2015/0137993 A1
(43) Pub. Date: May 21, 2015

(54) ENGINE AND SYSTEM MONITORING TELEMATIC SYSTEM

(71) Applicant: Kevin Terry, Uncasville, CT (US)

(72) Inventor: Kevin Terry, Uncasville, CT (US)

(73) Assignee: THOMAS G. FARIA CORPORATION, UNCASVILLE, CT (US)

(21) Appl. No.: 14/478,898

(22) Filed: Sep. 5, 2014

Related U.S. Application Data
(60) Provisional application No. 61/876,930, filed on Sep. 12, 2013.

(51) Int. Cl. H04W 76/02; H04Q 9/00; H04W 88/10; H04W 72/04; H04W 12/06

(52) U.S. Cl. CPC H04W 76/022; H04W 72/04; H04W 12/06; H04W 88/10; H04Q 9/00
USPC 340/870.07

(57) ABSTRACT

A marine vessel telematics device comprising: a remote access module configurable to plug into and be in signal communication with the data bus, the remote access module configurable to be in wireless signal communication with a hand held computing device and further configured to transmit to the hand held computing device marine vessel real-world data.

### CROSS-REFERENCES

This patent application claims the benefit of provisional patent application No. 61/876,930; by Kevin Terry, entitled “Engine and System Monitoring Telematic System”, filed on Sep. 12, 2013, and which provisional application is fully incorporated by reference herein.

### TECHNICAL FIELD

The present invention relates to the wireless transmission of engine, environmental, system, analog, and location information through a wireless network to a smart device, and then via the smart device to the internet.

### BACKGROUND

In order to monitor and diagnose issues with vehicles and vessels, current systems may monitor engine conditions, environmental conditions, and location information and transmit such data using stand-alone systems which are very expensive and/or time consuming to install, set-up and maintain. These systems typically require monthly service plans and dedicated modems.

Thus there is a need for an engine telematics system that overcomes the above and other disadvantages.

### SUMMARY OF THE INVENTION

The disclosed invention relates to a marine vessel telematics device comprising: a remote access module configurable to plug into and be in signal communication with the data bus, the remote access module configurable to be in wireless signal communication with a hand held computing device and further configured to transmit to the hand held computing device marine vessel real-world data.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic block diagram of one embodiment of the invention;

FIG. 2 is a schematic block diagram of another embodiment of the invention;

FIG. 3 is a schematic diagram of one embodiment of the invention;

FIG. 4 is a schematic block diagram of one embodiment of the invention;

FIG. 5 is a schematic block diagram of another embodiment of the invention;

FIG. 6 is a perspective view of the Wi-Fi module housing;

FIG. 7 is a flow chart of the data process;

FIG. 8 is a top view of the circuit board;

FIG. 9 is a call out sheet for the circuit board;

FIG. 10 is a front view of a remote access module:

FIG. 11 is a top view of a data bus with the remote access module attached to it;

FIG. 12 is a flow chart showing a method of having the remote access module connect with a user's computing device;

FIG. 13 is a flow chart showing a method of the remote access module communicating with a network, and the network able to communication with an unlimited number of Wi-Fi computing devices;

FIG. 14 shows one embodiment of a module interface window;

FIG. 15 shows one embodiment of details screen;

FIG. 16 shows the various data screens;

FIG. 17 shows one embodiment of a dashboard view on a user's computing device;

FIG. 18 shows one embodiment of a data log screen;

FIG. 19 shows one embodiment of combining satellite imagery with GPS capabilities to show the location of a marine vessel;

FIG. 20 shows one embodiment of the system providing automatic notifications, via SMS or Emails, when there are engine faults, or when vessel moves in and/or out of location based zones; and

FIG. 21 is a schematic view of another embodiment of the disclosed system.

### DETAILED DESCRIPTION

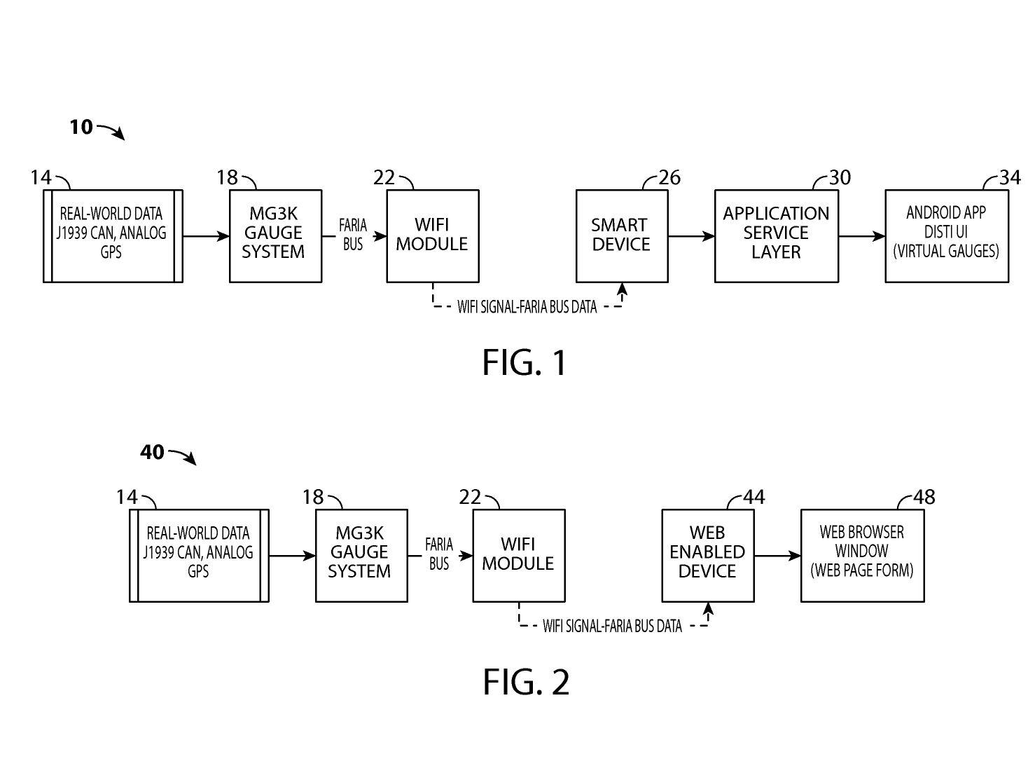

FIG. 1 is a schematic bock diagram of one embodiment of the disclosed system 10 in which a user interfaces with a smart device application (APP). Real-world data 14 is shown in signal communication with a gauge system 18. Real-world data may include, without limitation: voltage, temperature, linear velocity, rotational velocity, current, fluid levels, pressure, vacuum, time of operation, sea depth and location. Block 14 shows that the real-world data may comprise data from a J1939 vehicle bus with an integrated controller area network (CAN), analog signals (from sensors with analog outputs), and signals from a GPS system. The data from 14 is in communication with a gauge system 18, such as the MG3K gauge system in one embodiment. The MG3K (aka MG3000) is a feature-rich, intuitive engine monitoring solution for the instrument market. The digital instrumentation may communicate directly with the J1939, NMEA2000 and SmartCraft protocols used by the engine ECU providing an important link between the operator and the engine ECU. However, other gauge systems may be used. The gauge system 18 is signal communication with a Wi-Fi module 22. The Wi-Fi module 22 is in signal communication with a computing device 26, such as, but not limited to, a smart phone, android phone, IPhone, IPAD, android tablet, windows phone, windows tablet, etc. The computing device 26 is in signal communication with an application service layer 30, which in turn is in signal communication with an application (APP) 34 generally located on the smart device. The APP may be an android APP, apple APP, or windows APP, or any other suitable APP capable of running on a smart device. In one embodiment, the APP 34 may use a DISTI user interface (UI) which may show virtual gauges on the smart device, in this way a user can access the data from blocks 14 and 18. DISTI is a leading provider of advanced graphical user interface technology used to empower Human Machine Interface (HMI) development and virtual maintenance training.

FIG. 2 is a schematic block diagram of another embodiment of the disclosed system 40 wherein the user interfaces with a web page on a web enabled device. In this system, the Wi-Fi module is in signal communication with a web enabled device, such as a laptop computer, desktop computer, smart phone, tablet computer, other computing devices, etc. The user may interface with the system via a web page 48 on the web enabled device. In this way, the user can access the data from blocks 14 and 18. Throughout this patent application, numerous references will be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium. For example, a server can include one or more computers operating as a web server, database server, or other type of computer server in a manner to fulfill described roles, responsibilities, or functions. Within the context of this document, the disclosed smart phones, tablets, or hand held computers are also deemed to comprise computing devices having a processor and a non-transitory memory storing instructions executable by the processor that cause the device to control, manage, or otherwise manipulate the features of the assemblies.

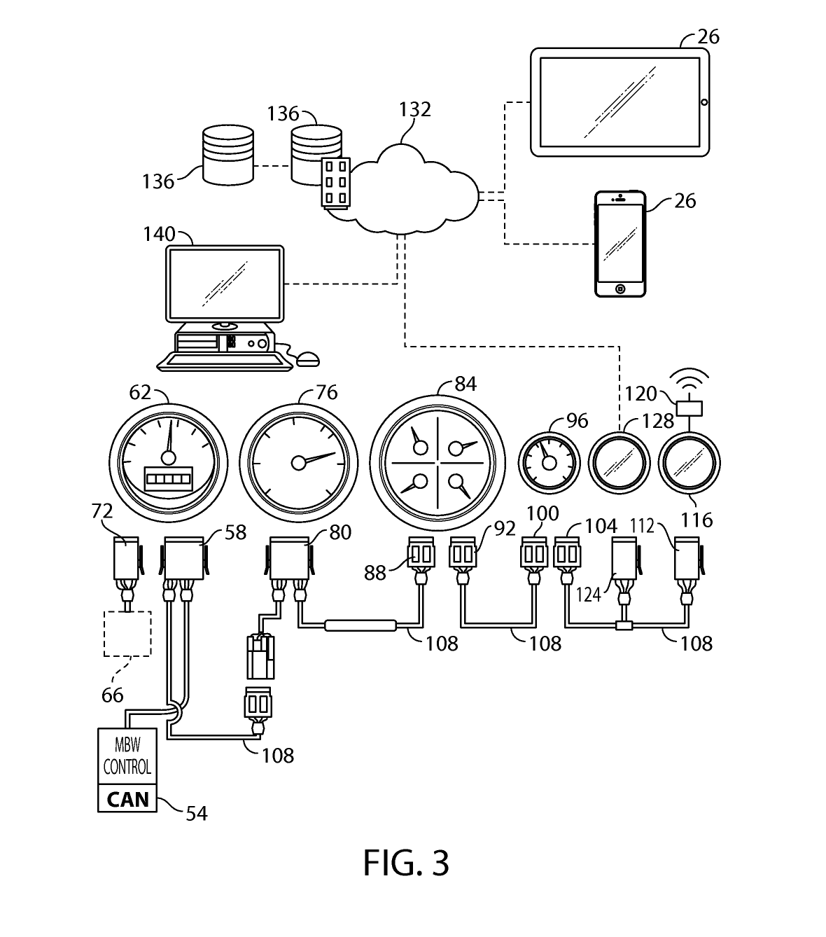

FIG. 3 is a schematic block diagram of another disclosed system 50. The Controller area network 54 is shown in communication with a tachometer connector 58, which is configured to plug into a tachometer 62. An optional GPS 66 may be in communication with a GPS connector 72 which may plug into the tachometer 62. A speedometer 76 may be in communication a speedometer connector 80. A multi-gauge gauge 84 may be in communication with a first multi-gauge connector 88, and a second multi-gauge connector 92. One or more other gauges 96 may be in communication with a first gauge connector 100 and optionally a second gauge connector 104. The tachometer 62, speedometer 76, multi-gauge gauge 84, and other gauges 96 may be all in communication with a data bus 108. In one embodiment, the gauges 62, 76, 84, 96 may be connected in a daisy chain configuration. The data bus 108 may be in signal communication with a wireless interface connector 112 which is attachable to a wireless interface 116 that has a Wi-Fi module 120. The Wi-Fi module 120 may be in signal communication with one or more smart devices 26. The smart devices 26 may be display the data via the means shown and described with respect to FIG. 1 or 2. Optionally, the data bus 108 may be in signal communication with a modem connector 124, and the modem connector may be in signal communication with a cellular modem 128. The cellular modem 128 may be in signal communication with a network 132. The network 132 may be in communication with servers 136. The network may also be in communication with a computing device 140. The computing device 140 may be located at an OEM's facility, a dealer's facility, or an end user. If located at the OEM or dealer facility, the OEM or dealer may assist the end user in diagnosing any issues with the vehicle or vessel.

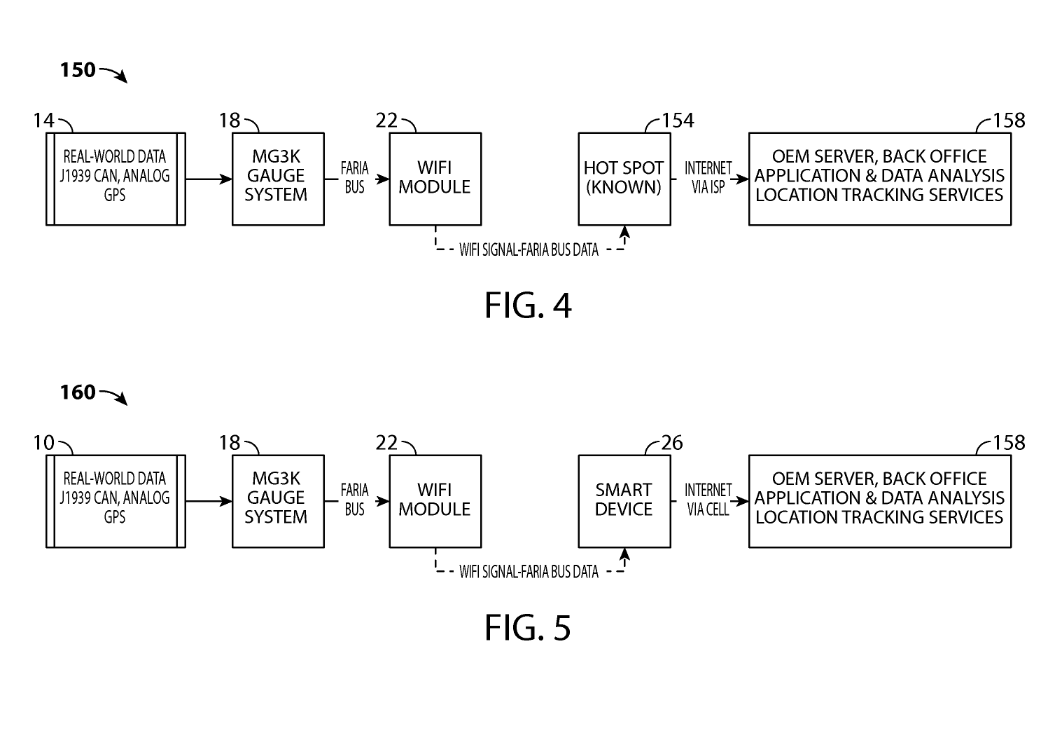

FIG. 4 is a schematic block diagram of another disclosed system 150. In this system, the Wi-Fi module 22 is in signal communication with a hot spot 154. A hot spot 154 may be a site that offers Internet access over a wireless local area network (WLAN) through the use of a router connected to a link to an Internet service provider. Hot spots may use Wi-Fi technology. The Hot spot 154 is in signal communication with back end systems 158, such, but not limited to an OEM server, a back office application and data analysis, and location tracking services.

FIG. 5 is a schematic block diagram of another disclosed system 160. In this system, the Wi-Fi module 22 is in signal communication with a computing device 26. The computing device 26 is in signal communication with back end systems 158, such, but not limited to an OEM server, a back office application and data analysis, and location tracking services.

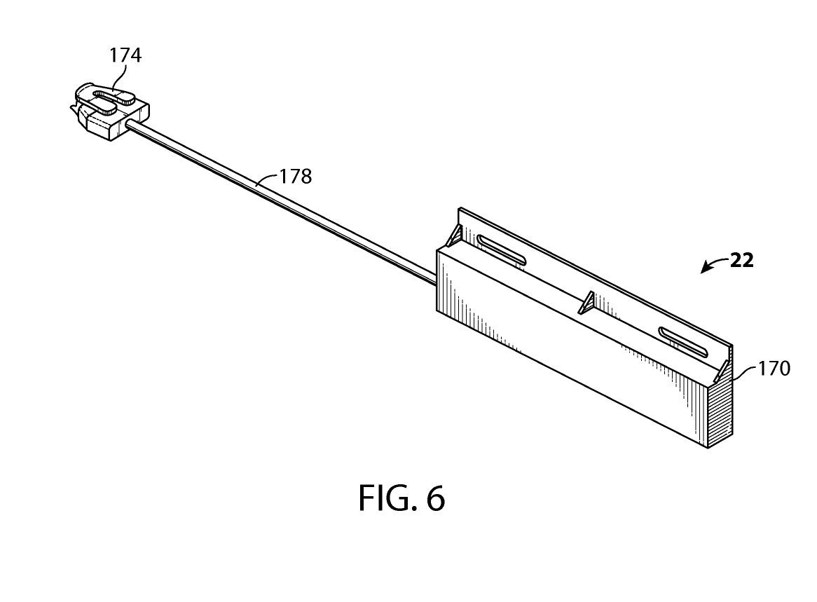

FIG. 6 is a perspective view of one embodiment of the Wi-Fi module 22. The Wi-Fi module 22 is located on a circuit board 182 (not visible in this view) located inside an enclosure 170. The circuit board is in signal communication with a wiring harness 174 via a multi conductor cable 178. The wiring harness 174 is configured to connect to the data bus 108.

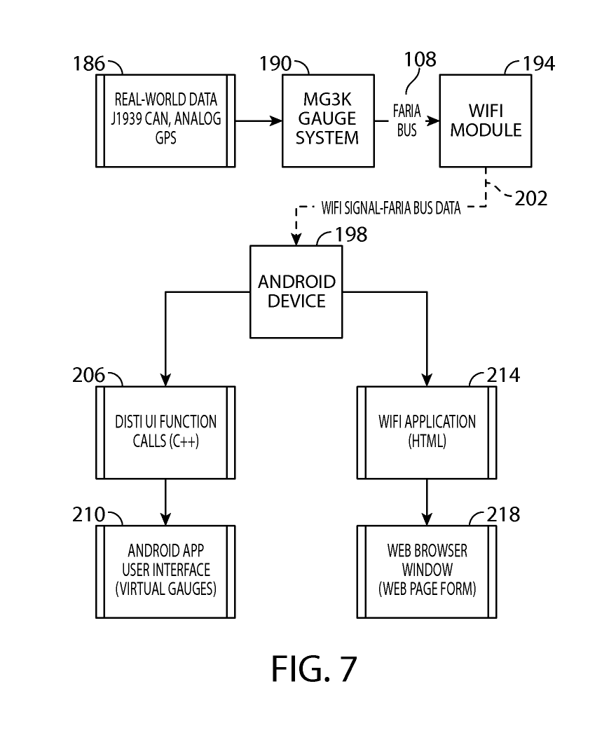

FIG. 7 is one embodiment of a data process flow diagram for the disclosed system. At block 186 real world data is obtained by the data bus J1939 CAN, analog signals from sensors, and signals from a GPS system. The data 186 is in signal communication with a gauge system 190, such as the MG3K gauge system. The MG3K gauge system 190 is in signal communication with a Wi-Fi module 194 via a data bus 108, such as the Faria Data bus. The Wi-Fi module is in signal communication, via a Wi-Fi signal 202, with computing device 198, such as, but not limited to a smart phone, android phone, IPHONE, tablet, etc. The computing device 198 may have resident in its memory or storage a DISTI user interface (UI) 206. The DISTI user interface UI 206 is in signal communication with an APP 210, such as an Android APP that provides user interface such as virtual gauges. The computing device 198 may have a Wi-Fi application written in HTML 214 resident in its memory and storage also. The Wi-Fi application 214 is in signal communication with a WEB Browser window in web page form that allows a user to access data via a web page, in addition to, or instead of the APP.

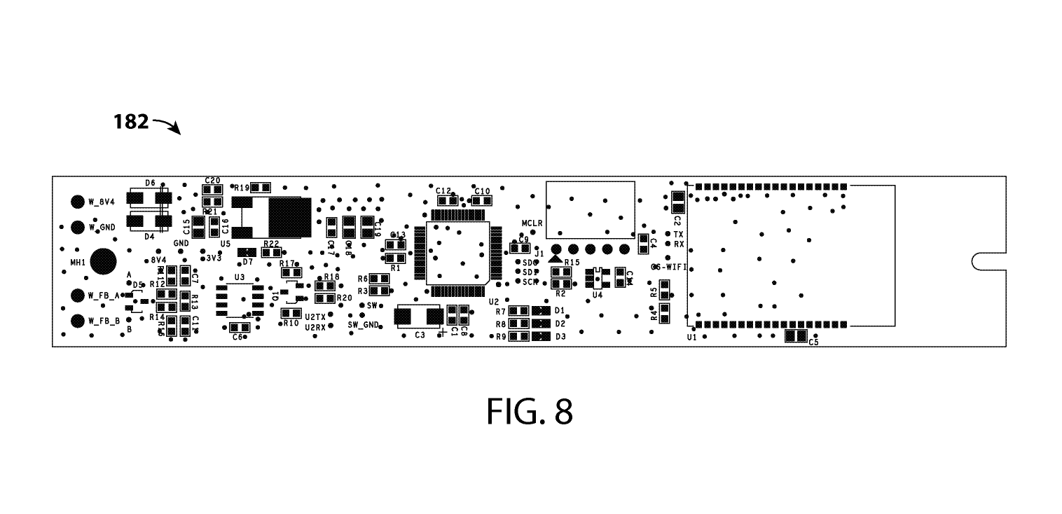

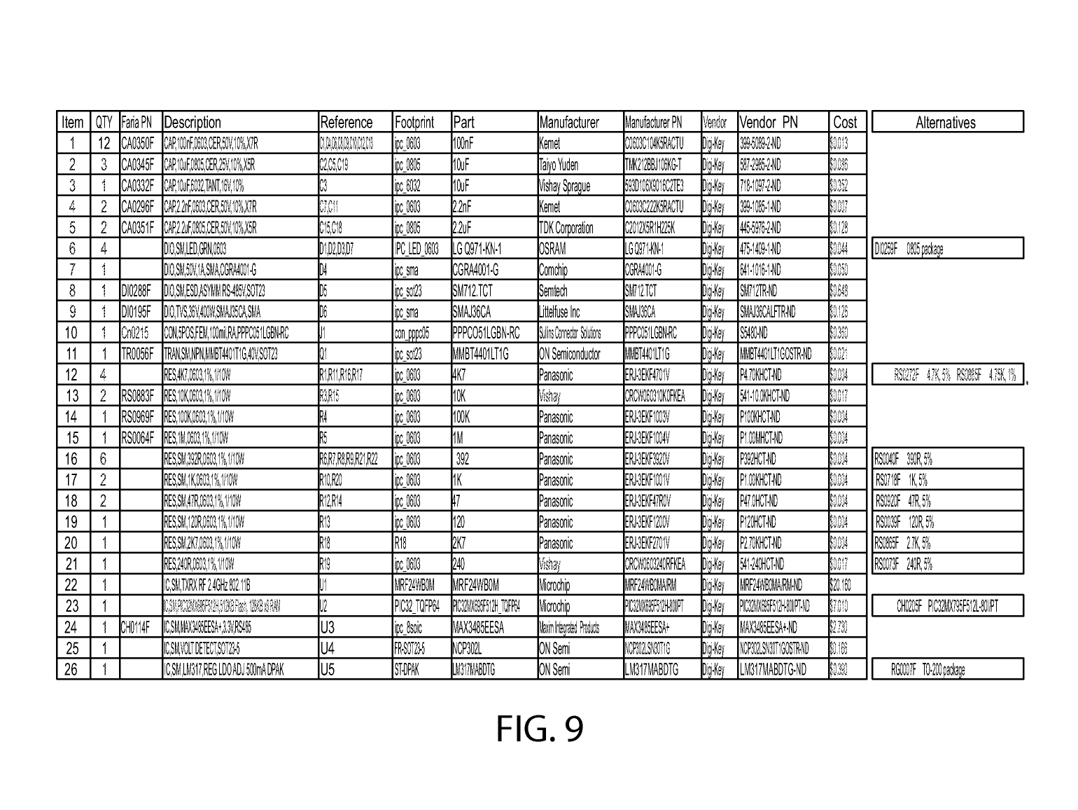

FIG. 8 is a top view of one embodiment of the circuit board 182. FIG. 9 is a call out of the components of the circuit board 182.

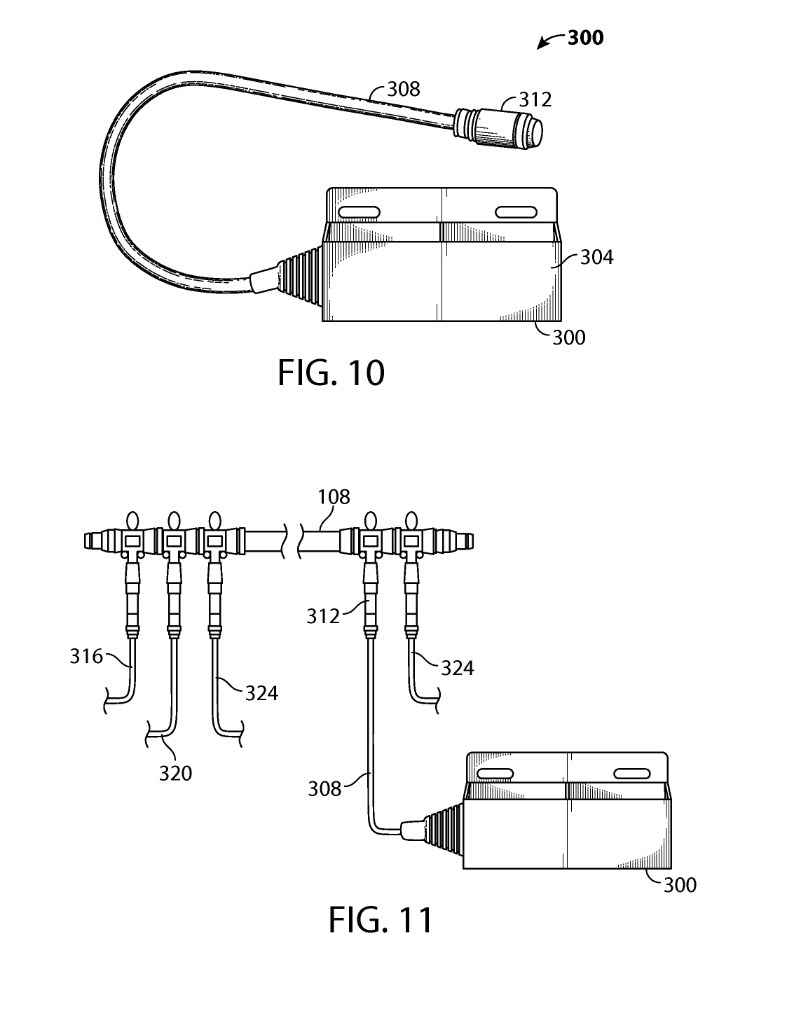

FIG. 10 shows one embodiment of a remote access module 300. The module comprises a housing 304, a cable 308, and a connector 312. The module 300 may be called an EntelNet module. The module 300 provides a variety of methods for remote access to engine and NMEA 2000 system data to devices without physical connection to the system. This module 300 may automatically connect to and communicate with all network devices, retrieve active network data, and provide a means for users to access this data using any web enabled (internet browser equipped) display device. All standard NMEA 2000 and OEM proprietary PGN's may be viewed using this device, and two-way communication with the network is possible as well. Any web capable, Wi-Fi equipped tablet, laptop, or smart phone may be used to communicate with the module 300. No custom software or apps are required for HTML only data view.

FIG. 11 shows how the module 300 can be connected to a data bus 108. The data bus 108 may be on the NMEA 2000 protocol. The module 300 may connect directly into an NMEA 2000 network backbone. All required power and data for the module 300 may come through this one connection at connector 312. The data bus 108 is shown connected to a cable 316 that may in signal communication with a port engine data monitor, and a cable 320 that may be in signal communication with a starboard engine data monitor, and with at least one cable 324 that may be in signal communication with NMEA 2000 devices

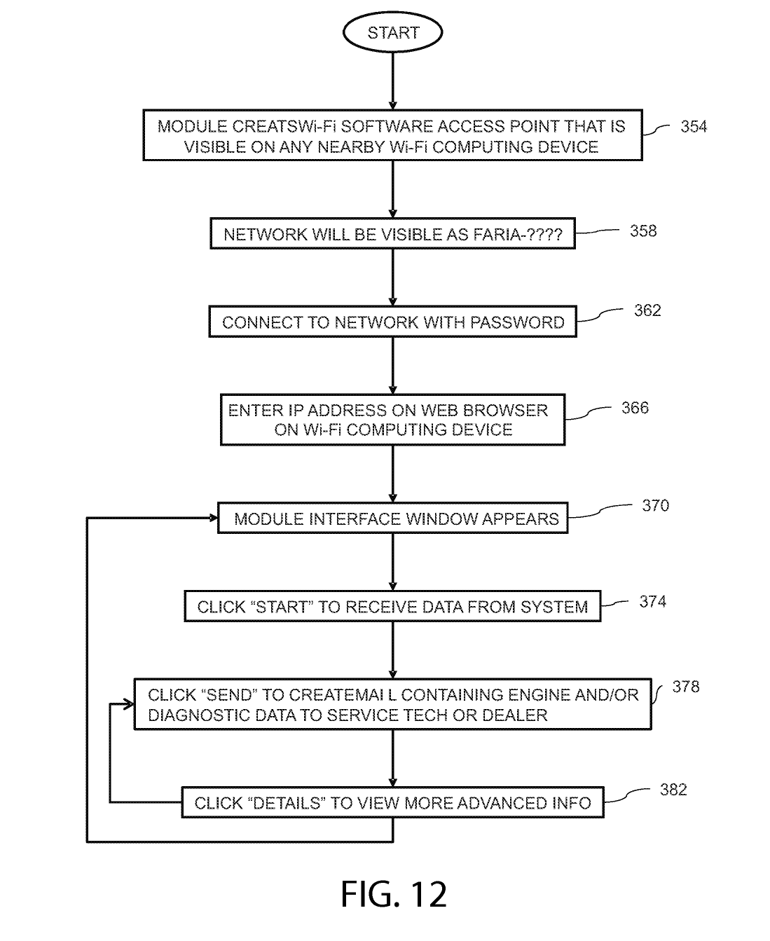

FIG. 12 is a flow chart showing a method of having the module 300 connect with a user's computing device and provide information about the marine vessel to the user's computing device. At act 354 the module, connected to a data bus such as a NMEA 2000 compliant data bus, the module will automatically create a limited range Wi-Fi Software Access Point (SoftAP) network. This SoftAP network will be visible on any nearby Wi-Fi display device (e.g., computing device, cell phone, tablet, etc.). At act 358, the created network will be visible as an identifiable network to the user, such as “FARIA_????”, where the “?” will be a random group of letters and numbers. At act 362, the user can connect to the created network on his or her Wi-Fi computing device using a password. At act 366 the user enters a system generated IP Address into a web browser on his or her computing device. At act 370, a module interface window appears on the user's Wi-Fi computing device. The interface window may show the local HTML code stored in the module. At act 374, the user may select “START” to receive data from the system, data such as, but not limited to engine monitoring data, diagnostic data, speed data, location data, and sea depth data. At act 378 the user may select “SEND” to create an email containing engine monitoring data, diagnostic data, speed data, location data, and sea depth data to a service technician or dealer who is also in communication with the internet. At act 382, the user may select “DETAILS” in order to view more advanced data and information on his or her Wi-Fi computing device. The data or information may be in graphical format, such as showing dials, levels, etc.

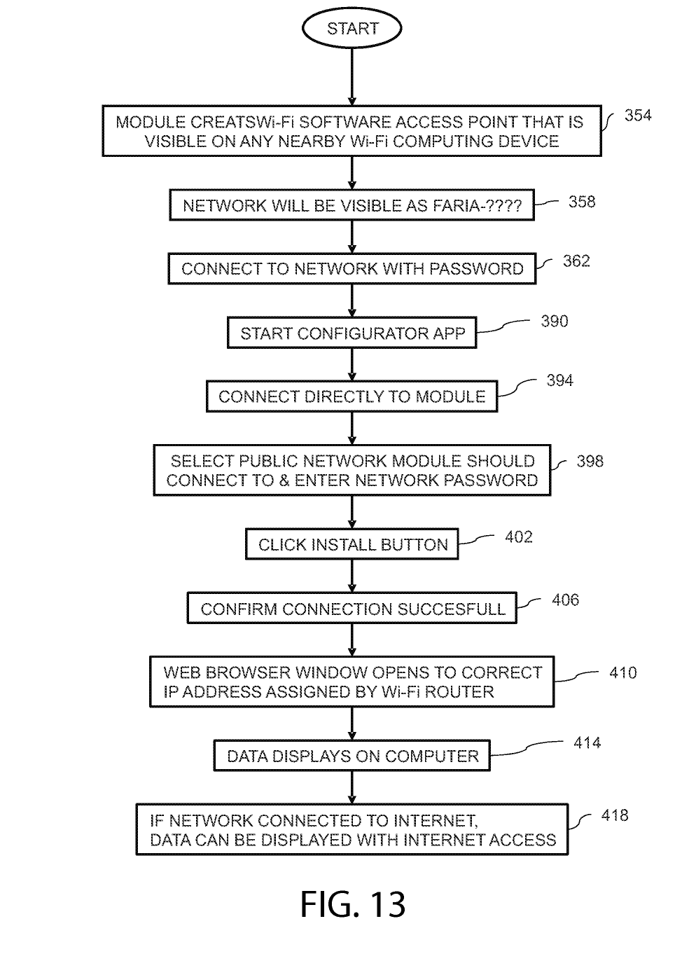

FIG. 13 shows a method of the module communicating with a network, and the network able to communication with an unlimited number of Wi-Fi computing devices. This method may generally start with acts 354, 358, and 362 described above. At act 390, the user starts a configurator app on his computing device. This act 390 may entail selecting a correct module from a list provided by the app, and then once the app is running, the computing device can connect directly to the module at act 394. At act 398, the user selects the public network the module should connect to and enter that network's password (if a password is required). At act 402, the user selects the “INSTALL” option. The user should then receive an indication that the public network connection to the module was successful, at act 406. At act 410, a web browser window may open connected to the correct IP address assigned by the public network's Wi-Fi router. The IP Address may vary as it may be assigned dynamically by the Wi-Fi router. The app can determine the proper IP address from the system so that the browser window navigates to the correct address. At act 414, engine monitoring data, diagnostic data, speed data, location data, sea depth data may display on the user's computing device. The user may now see generally the same data and information as described with respect to FIG. 12, but the user is viewing the data through the public network, therefore any number of tablets or other devices can view the same data at the same time. If the public network is in communication with the internet, then the marine vessel data and information can be displayed to anyone with internet access.

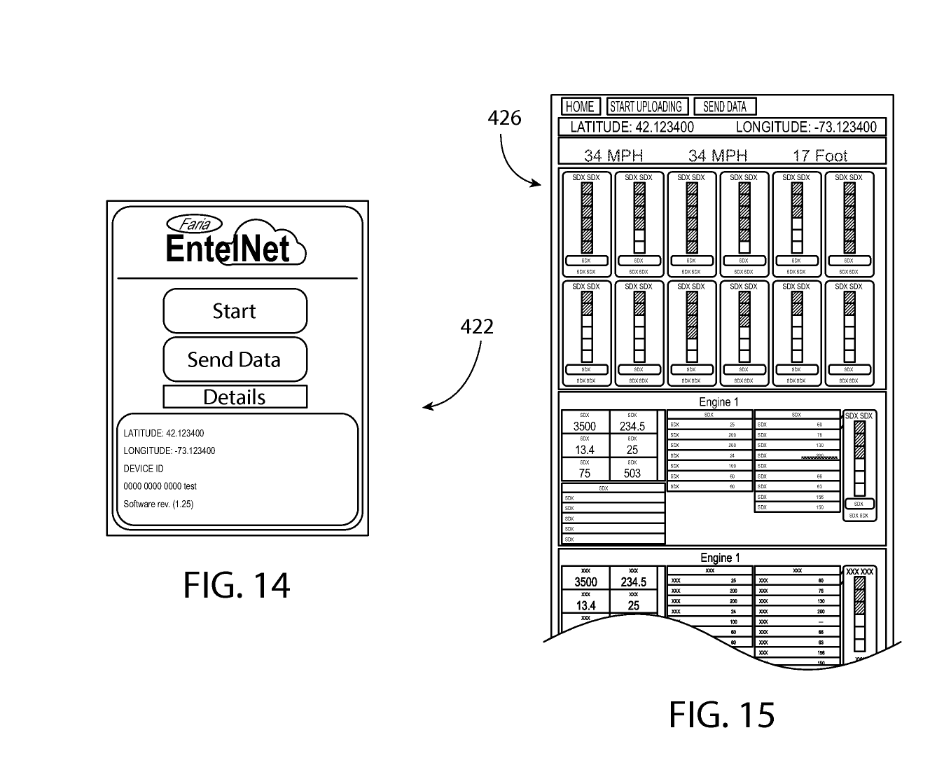

FIG. 14 shows one embodiment of the module interface window 422 described with respect to act 370 above.

FIG. 15 shows one embodiment of the details screen 426 described in act 382 above.

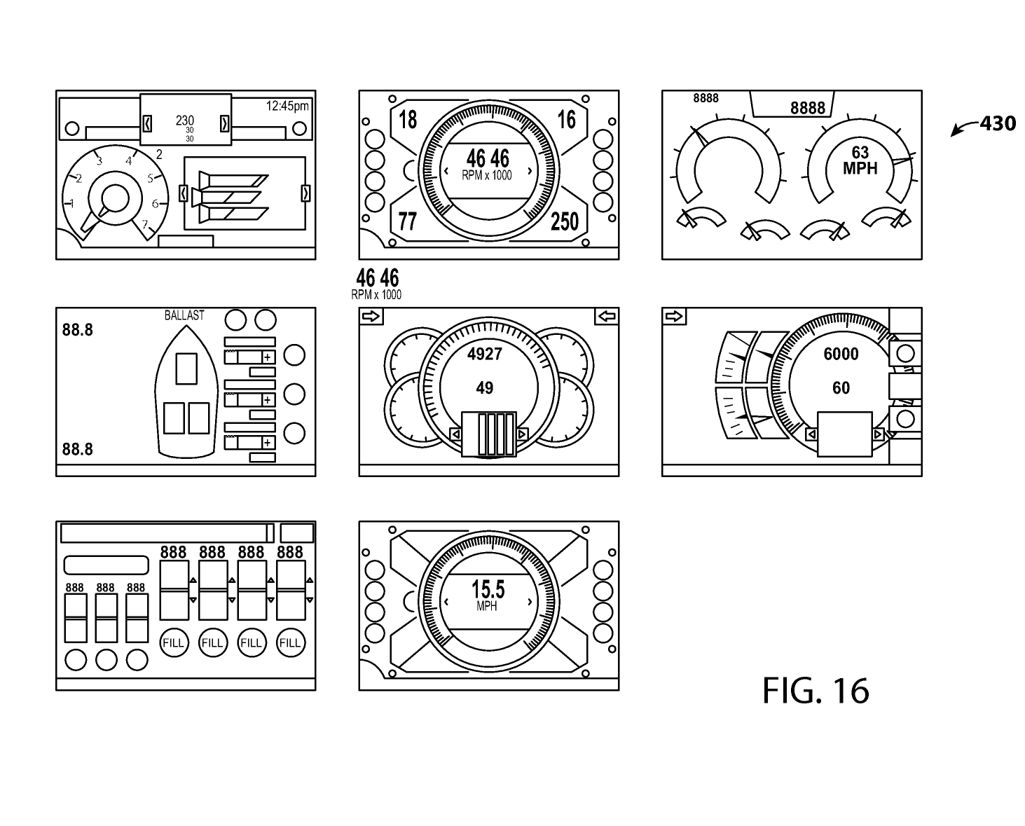

FIG. 16 shows the various possible data screens 430 that appear at act 414 above on the user's computing device.

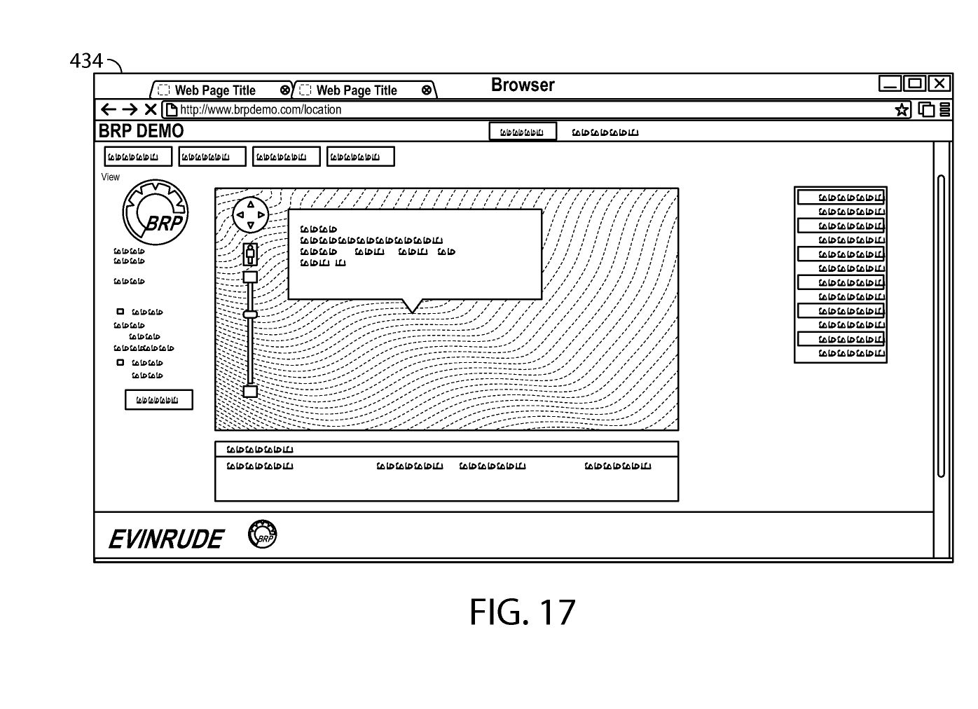

FIG. 17 shows one embodiment of a dashboard view 434 on a user's computing device when accessing the marine vessel data and info through the internet.

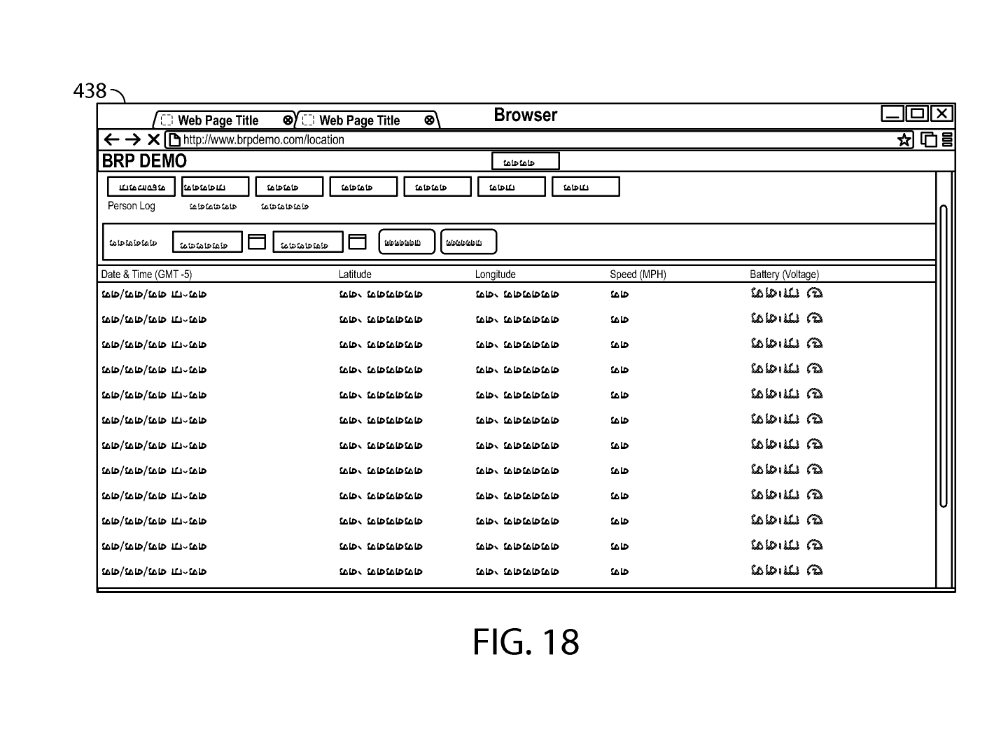

FIG. 18 is an example of one embodiment of a data log screen 438 that appears on a user's computing device. In this embodiment, the data log screen shows date/time, latitude, longitude, speed, and battery voltage. In other embodiments, different information may be provided.

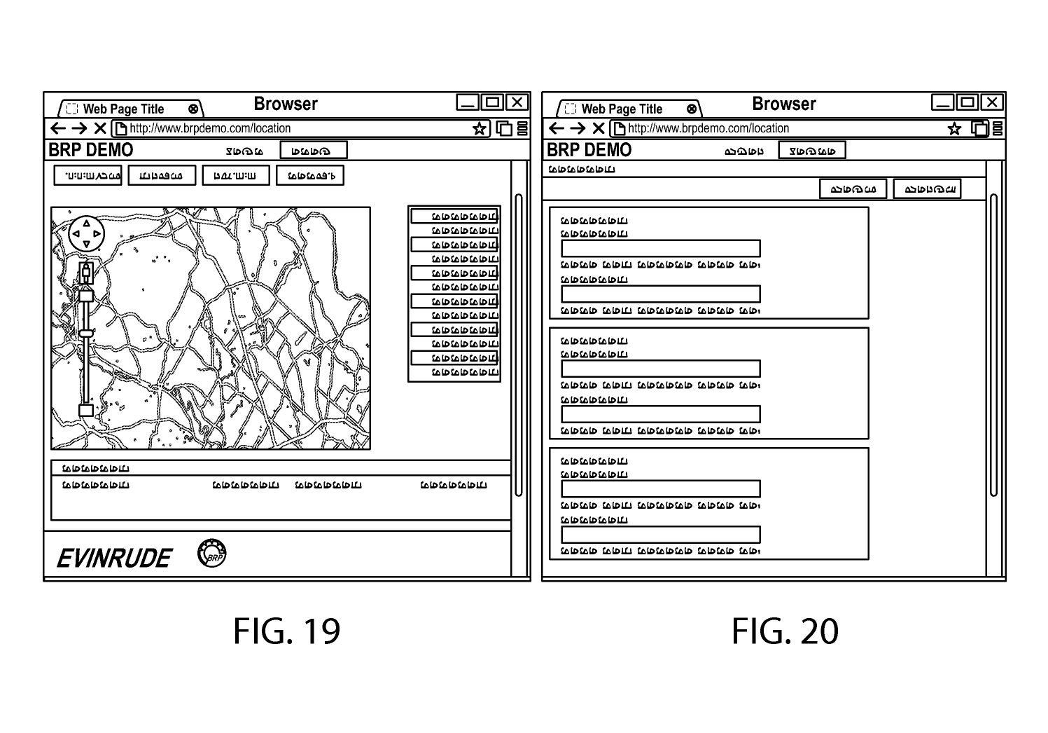

FIG. 19 shows a screen shot of one embodiment of combining satellite imagery with GPS capabilities to show the location of a marine vessel.

FIG. 20 shows a screen shot of one embodiment of the system providing automatic notifications, via SMS or Emails, when there are engine faults, or when vessel moves in and/or out of location based zones (perimeters, fences).

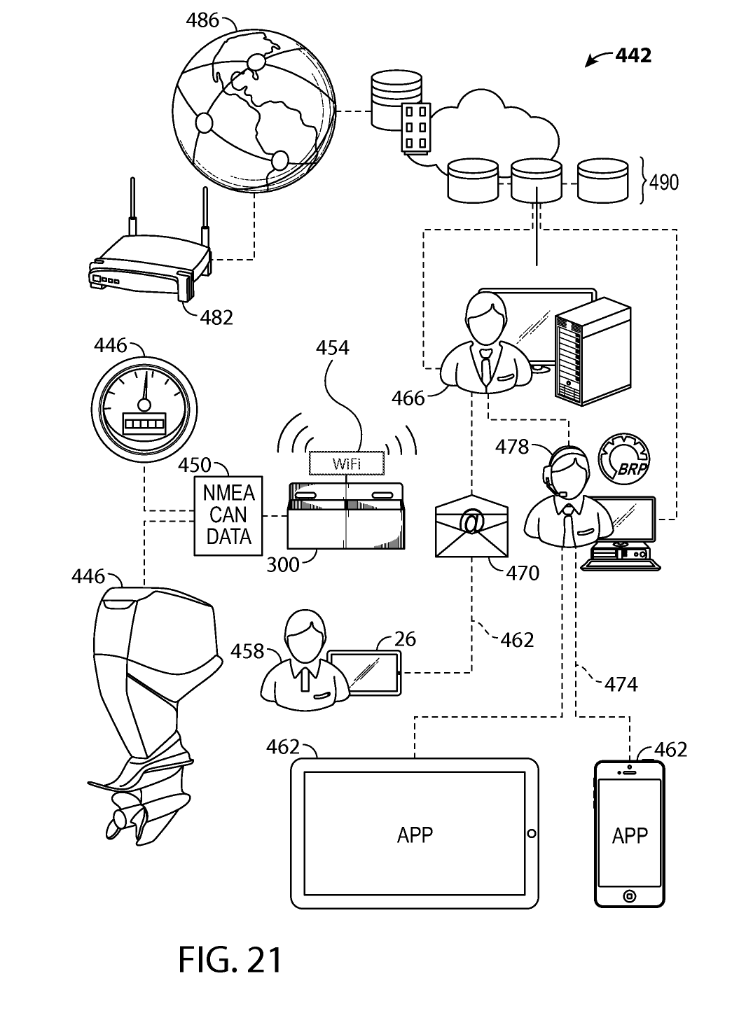

FIG. 21 is a schematic view of another embodiment of the disclosed system 442. The engine and gauge represents marine vessel data and information 446 such as engine monitoring data, diagnostic data, speed data, location data, and sea depth data from the vessel's data bus 450. A remote access module 300 is in communication with the data bus 450. The module 300 is in communication with a Wi-Fi transmitter/receiver 454. The module 300 may be in communication with a computing device 26 used by a user 458. Marine vessel data 462 from the remote access module 300 is shown on the computing device 26. Arrow 462 shows that the computing device 26 may communication with a dealer or technician 466 via email 470 or other electronic communications. Arrow 474 shows that the computing device 26 may be in communication with a repair team 478 who can analyze and recommend repair solutions to the user 458, and/or schedule repairs. The remote access module 300 may also be in communication with a network router 482 that may be in communication with the internet 486. Marine vessel data and information 446 such as engine monitoring data, diagnostic data, speed data, location data, sea depth data may then be in communication with data backup servers 490 as well as dealer or technicians 466 and/or repair team 478. In addition, once the module 300 is in communication with the internet 486, anyone with internet access, and the proper authorization, can access the user's marine vessel data and information.

The disclosed system may have a variety of operating modes. Some operating modes are listed below.

1. Distress Mode. The user may be outside of Wi-Fi range, but within cell phone range. There may be a problem with the engine. The user connects to the system via the direct access method explained with respect to FIG. 12 above with the user's computing device. The user downloads the engine data using the ‘Start’ button, and sends the engine data using the ‘Send’ button. The data is formatted into a text string pattern, and the user's own email program is used to present this data already pasted into an email. The address for the email can be defaulted to a certain service yard or OEM, or the user can enter a different email address to send this data to. The dealer, service yard, or other technician receives the email from this user, and is able to troubleshoot their system from the data received. The data can contain any diagnostic or engine fault information that resides on the system data bus. The service technician either calls or sends an email back to the user with instructions for correcting the problem, or for getting further assistance.

2. Configuration Mode. Since two-way communication between tablet (or phone) and the NMEA 2000 network, this system can be used to configure certain network based devices. Using proprietary PGN's or NMEA 2000 PGN 126208, devices with no user interface may be communicated with. Calibration of Fluid level sensors, Trim range, assignment of sensor instances, or other user inputs may be accomplished without the need for permanent displays installed in the vessel.

3. Service Mode-Automatic. The module may be configured with a Wi-Fi network SSID and password as explained previously. Every time the boat returns to port where the Wi-Fi system is located, engine hours and other data are uploaded to server as soon as the unit comes within range of the network. The web server formats this data into a report, that is sent via either notification method or other reporting method. A service yard receives report from the engine, and can evaluate status of engine, schedule maintenance, or other repair or revenue based activities.

4. Service Mode-Manual. Using either Direct access or Network mode explained previously, a service technician can access the NMEA 2000 network through the Wi-Fi network. Without getting onto boat, without opening network access panels, without removing shroud from engine, the engine data can be downloaded to technician's laptop or tablet. Diagnostic functions can be performed through this wireless connection.

5. Tracking Mode. Using a mobile hot-spot, on user's own cell phone plan, current location of boat and engine status can be uploaded real-time to tracking server. Vessel tracks can also be saved in EntelNet module while it is out of Wi-Fi range, and uploaded automatically to the server as soon as the vessel returns to network range (into port).

The disclosed system may rely on a microprocessor with TCP/IP stack and Wi-Fi interface enabled, such as Microchip PIC32 platform. The disclosed system may also rely on a Wi-Fi radio component, such as Microchip MRF24WBOM. The system may also rely on proprietary software, such as written by applicant company, to interpret CAN and other Analog or system data into a machine interpreted format for easy transmission between Wi-Fi module and smart device. The steps performed by the software is generally shown in FIGS. 12 and 13 above. Disti is one example of a GUI development tool, but Altia or similar platforms provide generally the same means for developing graphical user interfaces.

An example hardware mockup is given by Microchip Technology Inc., 2355 West Chandler Blvd., Chandler, Ariz., USA 85224-6199, in the form of their development system for these components. Microchip part number DV102411 may be used for the hardware mockup.

This invention may rely on loose infrastructure of web-enabled “smart” devices such as, but not limited to: smart phones, tablets, laptops to transmit the data to the “cloud” and/or web-based servers. This invention utilizes the ready availability of these smart devices, and their accompanying pre-existing data plans, to avoid specialized and expensive data plans for dedicated devices.

This invention may use localized radio transmission (Wi-Fi, Bluetooth) to transmit system data to a nearby user-owned or controlled smart device, whereby the user intervenes at that point to share the data to the cloud/web.

This invention may consist of a printed circuit board, populated with electronic components, including most importantly a microprocessor and a Wi-Fi and/or Bluetooth radio transmitter/receiver chip. This populated circuit board may be equipped with a wiring harness that connects to existing digital instrumentation or engine control units, and alternatively with analog senders, and alternatively GPS antenna, as well as other existing monitoring or sensing devices. The circuit/harness assembly is then mounted into an enclosure for protection from the environment.

The invention includes data input in various forms: CAN (J1939 or similar), Analog (resistance, voltage, etc.), or Serial (RS-232 for NMEA 0183, typical for GPS). This data is typically either engine specific (CAN), or from equipment sensors (Analog), or environmental/location related (GPS). An Android application (app) may be used in the Telematics project, this app resides on a common smart device (tablet, phone). Of course, the invention may be configured to work with an Apple app, or windows app, or any suitable app.

The invention may also be used without the use of the Android app. On any web-enabled device (iPhone, Windows laptop or tablet, etc.), MG3k data can be viewed inside a normal web browser window. No connection to the internet is necessary in this model. No installation of specialized apps or other software is necessary in this model.

In one embodiment, the invention may consist of a Wi-Fi module (puck) that plugs into the Faria Bus network (MG3k daisy-chained instruments). Faria Bus messages normally resident on the network are picked up by the puck, and broadcast on a local ad-hoc non-secure Wi-Fi network. This network is not normally connected to the Internet, it uses Wi-Fi radio solely for the transmission of data (Faria Bus origin) to a receiving client device, such as smart phone, laptop, or terminal.

In one embodiment, the production platform puck hardware consists of a single circuit board, mounted into a plastic enclosure, and encapsulated with potting compound. From one end of this enclosure extends a 4-wire harness with standard Faria Bus connector (Packard/Delphi 4-pin Plug, female terminals).

In one embodiment, the client device will connect to the Wi-Fi network using this procedure: Plug Wi-Fi puck into Faria Bus network, which is installed on an active vehicle/vessel capable of transmitting CAN and/or Analog data into the MG3k instruments (simulators may be used instead). Turn on the vehicle/vessel ignition (or simulator power). This will power up Faria Bus, and in turn the Wi-Fi module. The module will then create a point-to-point ad-hoc network. On your smart phone or other Wi-Fi capable device, access your wireless network settings (consult manufacturer instructions). You should see the network as ‘ MCHP_G_xxxx’ (xxxx will vary depending on hardware). Connect to this network. The client device will display the Faria Bus data using either of two methods—HTML or Android App Web Page Form (HTML)—Using existing Browser software already resident on client device (IE, Firefox, etc.), a discreet web page may be accessed. Navigating to this web page will be accomplished by typing the IP address of the Wi-Fi puck into the address bar of the browser window (such as 192.168.1.3 or similar). Once properly connected, a web page similar to the following will be displayed. On this page, real data from the Faria Bus will populate the various data windows Initial roll-out of this product will be primarily for technology and functional demonstration purposes with potential customers. This will require fully functional Faria Bus data for all fields that are currently broadcast on Faria Bus (Fuel %, Oil Level %, etc.), and static data for those items that are not on Faria Bus (Client ID, Vehicle ID, etc.).

Using the Graphical User Interface (GUI) developed in the DiSTi GL Studio environment, real data from the Faria Bus will be displayed in the virtual instruments and control devices on the LCD screen. This application (app) consists of multiple ‘pages’ of information, displayed in a graphical manner most recognizable as gauges and other numeric or ‘fill’ type level display methods. Below is the primary gauge screen.

The disclosed invention has many advantages. It allows a user to be able to send vessel and vehicle data to the OEM or dealer in order for the OEM or dealer to diagnose problems with the engine, vessel, or vehicle. The user can use his or her existing cellular service data plan, instead of purchasing a dedicated data plan such as ONSTAR. The disclosed invention is less expensive and easier to maintain because it can use the user's existing cell phone data plan and smart device to display data and/or transmit the data to the cloud.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of this disclosure and appended claim.

What is claimed is:

1. A marine vessel telematics device comprising:
a remote access module configurable to plug into and be in signal communication with the data bus, the remote access module configurable to be in wireless signal communication with a hand held computing device and further configured to transmit to the hand held computing device marine vessel real-world data.

2. The marine vessel telematics device of claim 1 further comprising:
a Wi-Fi transmitter/receiver located in the remote access module.

3. The marine vessel telematics device of claim 2, wherein the remote access module is configurable to be in wireless communication with a network.

4. The marine vessel telematics device of claim 3, where the network is the internet.

5. The marine vessel telematics device of claim 1, where the remote access module is compatible with the NMEA 2000 communications standard.

6. A marine vessel telematics system, comprising:
a data bus located on a marine vessel;
a remote access module physically connected to and in signal communication with the data bus;
a hand held computing device in wireless signal communication with the remote access module

7. The marine vessel telematics system of claim 6, wherein the hand held computing device is portable.

8. The marine vessel telematics system of claim 6, wherein the remote access module is configured to transmit to the hand held computing device marine vessel real-world data.

9. The marine vessel telematics system of claim 6, wherein the marine vessel telematics system is configured to:
create a Wi-Fi software access point network that is visible on any nearby Wi-Fi computing device;
the Wi-Fi software access point appears as “FARIA-????”, where the “?” are randomly generated characters;
connect the hand held computing devices to the Wi-Fi software access point network with a password;
allow a module interface window to appears on the hand held computing device, after an IP address is entered on a web browser on the hand held computing device;
transmit marine vessel real-world data from the remote access module to the hand held computing device when “START” is selected by the user in the module interface window;
create and transmit an email containing marine vessel real-world data to a service technician or dealer when “SEND” is selected by the user in the module interface window; and
allow marine vessel real-world data to be viewed on the hand held computing device when “DETAILS” is selected by the user in the module interface window.

10. The marine vessel telematics system of claim 6, wherein the marine vessel telematics system is configured to:
create a Wi-Fi software access point network that is visible on any nearby Wi-Fi computing device;
the Wi-Fi software access point appears as “FARIA-????”, where the “?” are randomly generated characters;
connect the hand held computing devices to the Wi-Fi software access point network with a password;
start configurator app on the hand held computing device;
hand held computing device connects directly and wirelessly to the remote access module;
select public network that remote access module connects to, enter password;
select “INSTALL” on hand held computing device;
confirm that remote access module connection to public network is successful,
web browser open on hand held computing device to correct IP address assigned by Wi-Fi router for public network;
marine vessel real-world data is displayed on hand held computing device;
marine vessel real-world data may be displayed on any hand held computing device in communication with the internet, if the public network is in communication with the internet.
